(19) United States
(12) Patent Application Publication
(10) Pub. No.: US 2024/0011843 A1
(43) Pub. Date: Jan. 11, 2024

(54) BACKSHELL ASSEMBLY

(71) Applicant: HarcoSemco LLC, Branford, CT (US)

(72) Inventor: William H. Hinman, Meriden, CT (US)

(73) Assignee: HarcoSemco LLC, Branford, CT (US)

(21) Appl. No.: 18/348,743

(22) Filed: Jul. 7, 2023

Related U.S. Application Data
(60) Provisional application No. 63/359,308, filed on Jul. 8, 2022.

(51) Int. Cl. G01K 1/08; H01R 31/06; H01R 13/52; G01K 7/02

(52) U.S. Cl. CPC G01K 1/08; H01R 31/065; H01R 13/5208; G01K 7/02; H01R 2201/20

(57) ABSTRACT

Provided is a backshell assembly including a backshell housing having a first end, a second end, a passage extending therebetween, and a radial groove in the passage, a connector coupled to the first end of the backshell housing, a header assembly disposed in the passage of the backshell housing, the header assembly including a header body, an insulating core disposed within the header body and including a plurality of openings, and a plurality of tubes extending through a respective one of the plurality of openings, and a seal disposed in the radial groove and surrounding the header body to seal the backshell housing to the header body.

### RELATED APPLICATIONS

This application claims the benefit of U.S. Provisional Patent Application No. 63/359,308 filed Jul. 8, 2022, which is hereby incorporated herein by reference.

### FIELD OF INVENTION

The present invention relates generally to a backshell assembly, and more particularly to a backshell assembly for an aircraft wire harness.

### BACKGROUND

Modern aircraft that are operating at high speeds are known to be subjected to great stress, strain and shock. Accordingly, the thermocouple apparatus must not only be adapted to elevated states and rapid changes of temperature, it must also be characterized by robust design and construction to reliably operate at these severe environmental conditions. Additionally, the thermocouples have to be located at points spaced about the periphery of the gas turbine tail cone or pipe in order to obtain meaningful temperature measurements. Furthermore, the thermocouples are mounted about the tail cone or pipe of a gas turbine in such a way that the failure of any one or more of the thermocouples does not affect or nullify the functioning of any other of the thermocouples, and so that their total or average indication is utilized as the significant value or measurement of gas stream temperature. These multiple thermocouple arrangements are conventionally characterized still further, and in one type by the connection of resistors in series with the thermocouples to balance or equalize their influence on the indicated output. In another form, the averaging may be carried out by circuitry or parallel connection of the thermocouples. In either case, the multiple or combined thermocouple arrangement continuously operating notwithstanding any damage or single point failures to the arrangement.

### SUMMARY OF INVENTION

According to an aspect, a backshell assembly is provided that includes a backshell housing having a first end, a second end, a passage extending therebetween, and a radial groove in the passage, a connector coupled to the first end of the backshell housing, a header assembly disposed in the passage of the backshell housing, the header assembly including a header body, an insulating core disposed within the header body and including a plurality of openings, and a plurality of tubes extending through a respective one of the plurality of openings, and a seal disposed in the radial groove and surrounding the header body to seal the backshell housing to the header body.

According to another aspect, a backshell assembly is provided that includes a backshell housing having a first end, a second end, a passage extending therebetween, and a radial groove in the passage, a header assembly disposed in the passage of the backshell housing, the header assembly including a header body, an insulating core disposed within and coupled to the header body and including a plurality of openings, and a plurality of tubes extending through a respective one of the plurality of openings, a seal disposed in the radial groove and surrounding the header body to seal the backshell housing to the header body, and a plurality of wires extending through a respective one of the plurality of tubes into the passage and being coupled to the respective one of the plurality of tubes.

According to still another aspect, a backshell assembly is provided that includes a backshell housing having a first end, a second end, a passage extending therebetween, a connector coupled to the first end of the backshell housing, a header assembly disposed in the passage of the backshell housing, the header assembly including a header body, an insulating core disposed within the header body and including a plurality of openings, and a plurality of tubes extending through a respective one of the plurality of openings, and a plurality of wires extending through a respective one of the plurality of tubes and into the passage.

The foregoing and other features of the application are described below with reference to the drawings.

### BRIEF DESCRIPTION OF THE DRAWINGS

FIG. 1 is a perspective view of an exemplary backshell assembly.

FIG. 2 is a side view of the backshell assembly

FIG. 3 is a cross-sectional view taken about line 3-3 in FIG. 2.

FIG. 4 is a cross-sectional view of a header assembly of the backshell assembly.

FIG. 5 is a cross-sectional view of another header assembly.

FIG. 6 is a cross-sectional view of another backshell assembly.

FIG. 7 is a cross-sectional view of still another backshell assembly.

FIG. 8 is a cross-sectional view of still another backshell assembly.

### DETAILED DESCRIPTION

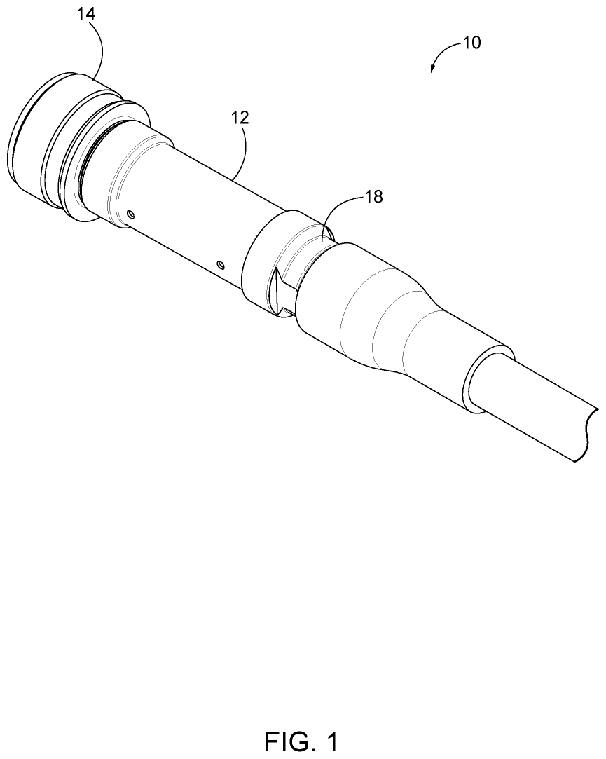

Turning now to FIGS. 1-3, a backshell assembly is shown generally at reference numeral 10. The backshell assembly provides a pressurized environmentally sealed assembly and includes a backshell housing 12, a connector 14 coupled to the backshell housing 12, a header assembly 16 disposed in the backshell housing 12, and a tailpiece 18 coupled to the backshell housing 12. The backshell housing 12 may be made of a suitable material, such as stainless steel, and may have a suitable shape, such as a substantially tubular shape. The backshell housing 12 includes a first end 20, a second end 22, and a passage 24 extending therebetween. The backshell housing 12 also can include threads 26 on a radially inner surface defining the passage 24 at the first end 20 for mating with threads 28 on the connector 14, and threads 30 on a radially outer surface near the second end 22 for mating with threads 32 on a radially inner surface of the tailpiece 18.

The backshell housing 12 also includes a seal groove 34 defined in the radially inner surface that defines the passage 24 for receiving a suitable seal, such as an O-ring 36 that surrounds the header assembly 16 and provides an environmental seal between the backshell housing 12 and the header assembly 16 that can withstand pressurized moisture and other contaminants. The O-ring 36 may be a suitable material, such as a fluoroelastomer having a temperature range around minus fifty-five degrees Celsius to two hundred thirty-two degrees Celsius.

Turning now to the connector 14, the connector 14 may be any suitable connector, such as a threaded MIL spec connector. The connector 14 is coupled to the backshell housing 12 by engaging the threads 28 with the threads 26 until an end 40 of the connector 14 abuts an inner shoulder 42 in the passage 24. The threads 26 and 28 may be coated with a suitable epoxy to provide an environmental seal at the threaded connection. A suitable seal, such as a polymer grommet 44 may also be provided that abuts the end 40 of the connector 14 and seals against the radially inner surface defining the passage 24 creating an environmental seal between the backshell housing 12 and the connector 14 that can withstand pressurized moisture and other contaminants.

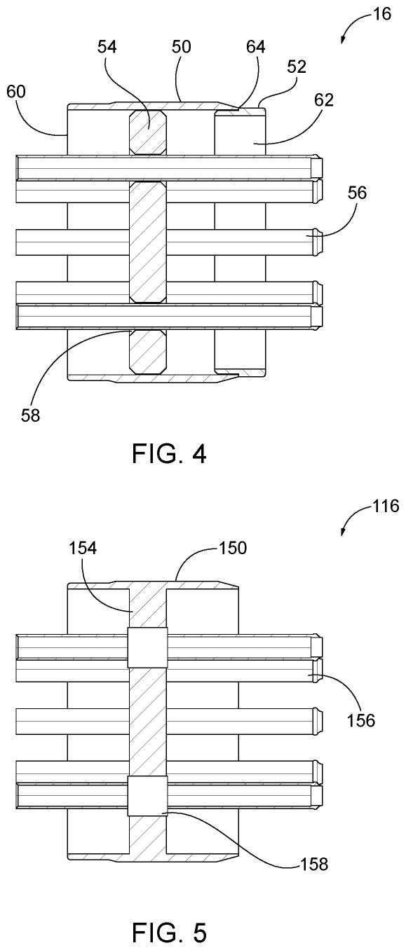

Turning additionally to FIG. 4 and the header assembly 16 in detail, the header assembly 16 includes a header body 50, a sleeve 52 coupled to the header body 50, an insulating core 54 disposed within and coupled to the header body and a plurality of tubes 56 extending through and being coupled to respective openings 58 in the core 54. The header body 50 and sleeve 52 may each be substantially tubular and include a respective passage 60, 62 extending therethrough through which the tubes 56 extend. The header body 50 may be made of a suitable metal, such as titanium and the sleeve 52 may be made of a suitable metal that is coupled to the header body 50 in a suitable manner, such as by brazing. The sleeve 52 may include a shoulder 64 on an outer surface thereof against which an end of the header body 50 abuts providing a connection area for connecting the header body 50 and sleeve 52. The header body 50 and/or the sleeve 52 may be coupled to the backshell housing 12 in the passage 24 to prevent movement of the header assembly 16 relative to the backshell housing 12, for example by a suitable weld, such as a tack weld.

The insulating core 54 may be coupled to the header body 50 in the passage 60 in a suitable manner, such as by brazing. The insulating core 54 includes the plurality of circumferentially spaced openings 58 each configured to have extending therethrough one of the plurality of tubes 56. The insulating core 54 may be made of a suitable material, such as a ceramic, such as alumina oxide providing electrical isolation and fixturing of wires, and the plurality of tubes 56 may be made of a suitable material, such as stainless steel. The tubes 56 are coupled to the respective openings 58 in a suitable manner, such as by brazing. As will be described in more detail below, wires, such as thermocouple wires, may extend through the tubes 56 and into the passage 24, and may themselves be coupled to the tubes 56 in a suitable manner, such as by brazing to create a hermetic seal.

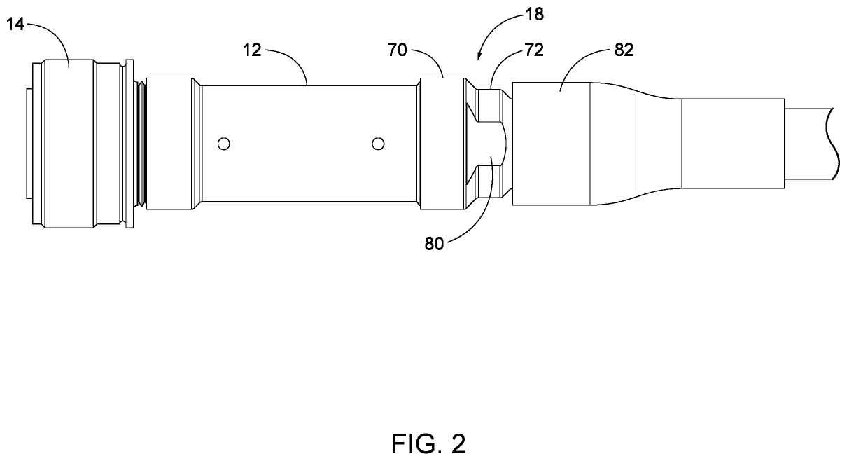

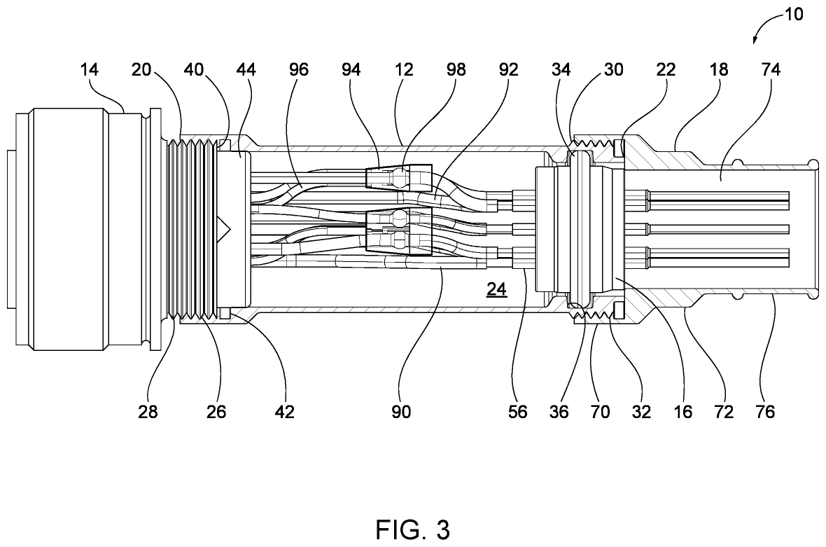

Turning now to the tailpiece 18 and again to FIGS. 2 and 3, the tailpiece 18 includes a first portion 70 having a first diameter for surrounding the second end 22 of the backshell housing 12, a second portion 72 having a second diameter less than the first diameter, and a passage 74 extending through the first and second portions 70 and 72. It will be appreciated, however, that the tailpiece 18 may have any suitable configuration, such as having a uniform diameter or having more than two portions.

The first portion 70 includes the threads 32 on the radially inner surface defining the passage 74 for engaging with the threads 30 on the radially outer surface of the backshell housing 12, and the threads 30 and 32 may be coated with a suitable epoxy to provide an environmental seal at the threaded connection.

The second portion 72 may include an annular groove 76 for receiving a clip that is coupled to other otherwise associated with the braiding surrounding the wires, and may include one or more flats 80 for receiving a suitable tool for tightening the tailpiece 18 relative to the backshell housing 12. A suitable sleeve 82 shown in FIG. 2 may be placed over the clip or used in place of the clip.

As shown in FIG. 3, the backshell assembly 10 can also include, or be utilized to work with, one or more wires, such as thermocouple wires, such as one or more nickel chromium (NiCr) wires 90 and one or more nickel aluminum (NiAl) wires 92. When the backshell assembly 10 is assembled, the NiCr and NiAl wires 90 and 92 extend through the passage 74 in the tailpiece 18 and through a respective one of the tubes 56, where the wires 90 and 92 are brazed to the respective tube 56 to create a hermetic seal. The wires 90 and 92 also extend through the tubes 56 into the passage 24 and to the connector 14 where the wires and 92 can terminate at contacts installed into the connector 14. The wires in the passage 24 can be insulated in a suitable manner, such as by shrink sleeving. In an embodiment as shown, one or more of the wires 90 and 92 may be coupled to sensors 94 in the passage 24, such as cold junction compensation temperature sensors, which in turn are coupled to electrical wires 96 that extend into the connector 14 where they can terminate at contacts installed into the connector 14. The coupling of the wires 90 and 92, the wires 96, and the cold junction compensation temperature sensors 94 create cold junctions, and the sensors 94 are configured to measure localized temperature of the cold junctions. Shrink sleeves 98 may be positioned over the sensors and wires at the cold junctions. The sensors 94 may be suitable sensors, such as thin film resistance temperature detectors, wire round resistance temperature detectors, NTS resistance temperature detectors, etc.

Turning now to FIG. 5, an exemplary embodiment of the header assembly is shown at 116. The header assembly 116 is substantially the same as the above-referenced header assembly 16, and consequently the same reference numerals but indexed by 100 are used to denote structures corresponding to similar structures in the header assemblies. In addition, the foregoing description of the header assembly 16 is equally applicable to the header assembly 116 except as noted below.

The header assembly 116 includes a header body 150 and a core 154 integrally formed with one another and made of a suitable metallic material, such as titanium. A plurality of openings or through holes extend through the core 154 and are hermetically sealed by insulating regions 158 in a suitable manner, such as by a ceramic or glass material. A plurality of tubes 156 extend through and are coupled to the respective openings in the core 154 in a suitable manner, such as by brazing. The header body 150 may be coupled to the backshell housing 12 in the passage 24 to prevent movement of the header assembly 116 relative to the backshell housing 12, for example by a suitable weld, such as a tack weld.

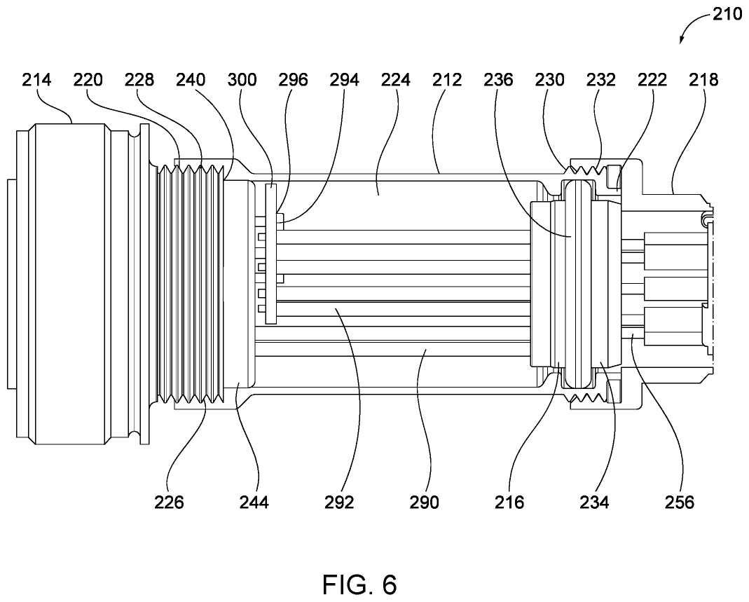

Turning now to FIG. 6, an exemplary embodiment of the backshell assembly is shown at 210. The backshell assembly 210 is substantially the same as the above-referenced backshell assembly 10, and consequently the same reference numerals but indexed by 200 are used to denote structures corresponding to similar structures in the backshell assemblies. In addition, the foregoing description of the backshell assembly 10 is equally applicable to the backshell assembly 210 except as noted below.

The backshell assembly 210 includes a backshell housing 212, a connector 214 coupled to the backshell housing 212, a header assembly 216 disposed in the backshell housing 212, and a tailpiece 218 coupled to the backshell housing 212. The backshell housing 212 may be made of a suitable material, such as stainless steel, and may have a suitable shape, such as a substantially tubular shape.

The backshell housing 212 includes a first end 220, a second end 222, and a passage 224 extending therebetween. The backshell housing 212 also can include threads 226 on a radially inner surface defining the passage 224 at the first end 220 for mating with threads 228 on the connector 214, and threads 230 on a radially outer surface near the second end 222 for mating with threads 232 on a radially inner surface of the tailpiece 218. The backshell housing 212 also includes a seal groove 234 that is defined in the radially inner surface that defines the passage 224 for receiving a suitable seal, such as an O-ring 236 that surrounds the header assembly 216. A suitable seal, such as a polymer grommet 244 may be provided that abuts an end 240 of the connector 214 and seals against the radially inner surface defining the passage 224. The header assembly 216 may be substantially the same as either header assembly 16 or 116 and include a plurality of tubes 256 extending through and being coupled to the header assembly.

The backshell assembly 210 can also include, or be utilized to work with, one or more wires, such as thermocouple wires, such as one or more NiCr wires 290 and one or more NiAl wires 292. When the backshell assembly 210 is assembled, the NiCr and NiAl wires 290 and 292 extend through the tailpiece 218 and through a respective one of the tubes 256, where the wires 290 and 292 are brazed to the respective tube 256 to create a hermetic seal. The wires 290 and 292 also extend through the tubes 256 into the passage 224 and are connected to a printed circuit board (PCB) 300 that can be connected to the pins of the connector 214. The PCB 300 may be a suitable PCB, such as one made from glass-reinforced epoxy laminate material or alumina. One or more sensors 294, such as a surface mounted resistance temperature detector, may be mounted to the PCB 300 to measure localized temperature of cold junctions 296.

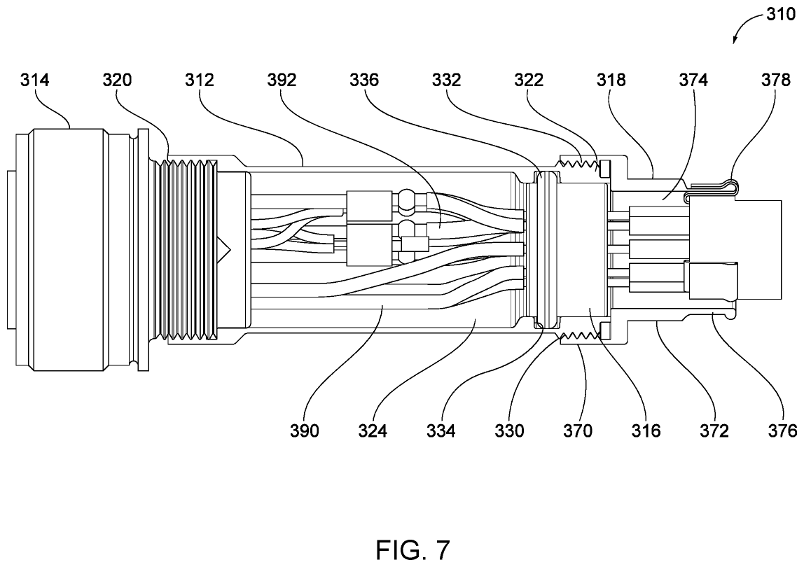

Turning now to FIG. 7, an exemplary embodiment of the backshell assembly is shown at 310. The backshell assembly 310 is substantially the same as the above-referenced backshell assembly 10, and consequently the same reference numerals but indexed by 300 are used to denote structures corresponding to similar structures in the backshell assemblies. In addition, the foregoing description of the backshell assembly 10 is equally applicable to the backshell assembly 310.

The backshell assembly includes a backshell housing 312, a connector 314 coupled to the backshell housing 312, a header assembly 316 disposed in the backshell housing 312, and a tailpiece 318 coupled to the backshell housing 312. The backshell housing 312 includes a first end 320, a second end 322, and a passage 324 extending therebetween. The backshell housing 312 also includes a seal groove 334 defined in the radially inner surface that defines the passage 324 for receiving a suitable seal, such as an O-ring 336 that surrounds the header assembly 316 and provides an environmental seal between the backshell housing 312 and the header assembly 316.

The tailpiece 318 includes a first portion 370 having a first diameter for surrounding the second end 322 of the backshell housing 312, a second portion 372 having a second diameter less than the first diameter, and a passage 374 extending through the first and second portions 370 and 372.

The first portion 370 includes threads 332 on the radially inner surface defining the passage 374 for engaging with the threads 330 on the radially outer surface of the backshell housing 312. The second portion 372 may include an annular groove 376 for receiving a clip 378 that is coupled to other otherwise associated with the braiding surrounding the wires.

The backshell assembly 310 can also include, or be utilized to work with, one or more wires, such as thermocouple wires, such as one or more nickel chromium (NiCr) wires 390 and one or more nickel aluminum (NiAl) wires 392.

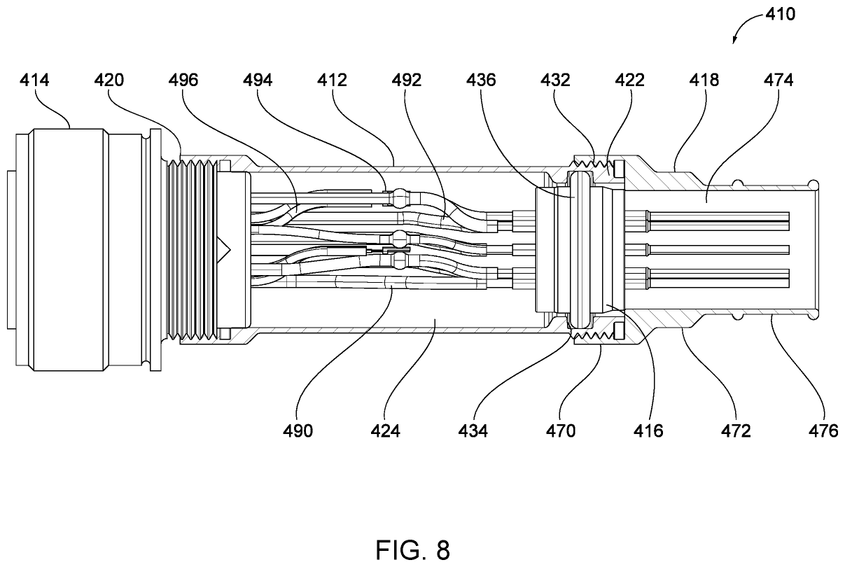

Turning now to FIG. 8, an exemplary embodiment of the backshell assembly is shown at 410. The backshell assembly 410 is substantially the same as the above-referenced backshell assembly 10, and consequently the same reference numerals but indexed by 400 are used to denote structures corresponding to similar structures in the backshell assemblies. In addition, the foregoing description of the backshell assembly 10 is equally applicable to the backshell assembly 410.

The backshell assembly includes a backshell housing 412, a connector 414 coupled to the backshell housing 412, a header assembly 416 disposed in the backshell housing 412, and a tailpiece 418 coupled to the backshell housing 412. The backshell housing 412 includes a first end 420, a second end 422, and a passage 424 extending therebetween. The backshell housing 412 also includes a seal groove 434 defined in the radially inner surface that defines the passage 424 for receiving a suitable seal, such as an O-ring 436 that surrounds the header assembly 416 and provides an environmental seal between the backshell housing 412 and the header assembly 416.

The tailpiece 418 includes a first portion 470 having a first diameter for surrounding the second end 422 of the backshell housing 412, a second portion 472 having a second diameter less than the first diameter, and a passage 474 extending through the first and second portions 470 and 472.

The first portion 470 includes threads 432 on the radially inner surface defining the passage 474 for engaging with the threads 430 on the radially outer surface of the backshell housing 412. The second portion 472 may include an annular groove 476 for receiving a clip 478 that is coupled to other otherwise associated with the braiding surrounding the wires.

The backshell assembly 410 can also include, or be utilized to work with, one or more wires, such as thermocouple wires, such as one or more nickel chromium (NiCr) wires 490 and one or more nickel aluminum (NiAl) wires 492. One or more of the wires 490 and 492 may be coupled to sensors 494 in the passage 424, such as cold junction compensation temperature sensors, which in turn are coupled to electrical wires 496 that extend into the connector 414 where they can terminate at contacts installed into the connector 414. The coupling of the wires 490 and 492, the wires 496, and the cold junction compensation temperature sensors 494 create cold junctions, and the sensors 494 are configured to measure localized temperature of the cold junctions. As shown, shrink sleeves are not provided over the sensors and wires at the cold junctions.

Although certain embodiments have been shown and described, it is understood that equivalents and modifications falling within the scope of the appended claims will occur to others who are skilled in the art upon the reading and understanding of this specification.

What is claimed is:

1. A backshell assembly comprising:
a backshell housing having a first end, a second end, a passage extending therebetween, and a radial groove in the passage;
a connector coupled to the first end of the backshell housing;
a header assembly disposed in the passage of the backshell housing, the header assembly including a header body, an insulating core disposed within the header body and including a plurality of openings, and a plurality of tubes extending through a respective one of the plurality of openings; and
a seal disposed in the radial groove and surrounding the header body to seal the backshell housing to the header body.

2. The backshell assembly according to claim 1, wherein the plurality of openings in the insulating core include a plurality of circumferentially spaced openings, and wherein the plurality of tubes extend through the respective one of the plurality of circumferentially spaced openings and are coupled to the insulating core at the respective opening.

3. The backshell assembly according to claim 1, further comprising a plurality of wires extending through a respective one of the plurality of tubes and into the passage.

4. The backshell assembly according to claim 3, wherein the plurality of wires are coupled to the respective tube.

5. The backshell assembly according to claim 4, wherein the plurality of wires are thermocouple wires.

6. The backshell assembly according to claim 5, wherein the thermocouple wires include one or more nickel chromium wire and one or more nickel aluminum wire.

7. The backshell assembly according to claim 3, wherein one or more of the wires is coupled to a respective sensor in the passage.

8. The backshell assembly according to claim 7, wherein the sensor is a cold junction compensation temperature sensor.

9. The backshell assembly according to claim 7, wherein the sensor is coupled to an electrical wire that is coupled to a contact in the connector.

10. The backshell assembly according to claim 1, further comprising a tailpiece coupled to the second end of the backshell housing.

11. The backshell assembly according to claim 10, wherein the backshell housing has threads on a radially outer surface at the second end for mating with threads on a radially inner surface of the tailpiece.

12. The backshell assembly according to claim 1, wherein the backshell housing includes threads on a radially inner surface at the first end for mating with threads on a radially outer surface of the connector.

13. The backshell assembly according to claim 12, further comprising a seal abutting an end of the connector disposed within the passage that seals the connector to the radially inner surface of the backshell housing.

14. A backshell assembly comprising:
a backshell housing having a first end, a second end, a passage extending therebetween, and a radial groove in the passage;
a header assembly disposed in the passage of the backshell housing, the header assembly including a header body, an insulating core disposed within and coupled to the header body and including a plurality of openings, and a plurality of tubes extending through a respective one of the plurality of openings;
a seal disposed in the radial groove and surrounding the header body to seal the backshell housing to the header body; and
a plurality of wires extending through a respective one of the plurality of tubes into the passage and being coupled to the respective one of the plurality of tubes.

15. The backshell assembly according to claim 14, wherein the plurality of tubes extend through the respective one of the plurality of openings and are coupled to the insulating core at the respective opening.

16. The backshell assembly according to claim 14, further comprising a tailpiece coupled to the second end of the backshell housing, wherein the backshell housing has threads on a radially outer surface at the second end for mating with threads on a radially inner surface of the tailpiece.

17. The backshell assembly according to claim 14, further comprising one or more cold junction compensation temperature sensors disposed in the passage, wherein one or more of the plurality of wires are coupled to a respective one of the one or more cold junction compensation temperature sensors.

18. A backshell assembly comprising:
a backshell housing having a first end, a second end, a passage extending therebetween;
a connector coupled to the first end of the backshell housing;
a header assembly disposed in the passage of the backshell housing, the header assembly including a header body, an insulating core disposed within the header body and including a plurality of openings, and a plurality of tubes extending through a respective one of the plurality of openings; and
a plurality of wires extending through a respective one of the plurality of tubes and into the passage.

19. The backshell assembly according to claim 18, further comprising one or more cold junction compensation temperature sensors disposed in the passage, wherein one or more of the plurality of wires are coupled to a respective one of the one or more cold junction compensation temperature sensors.

20. The backshell assembly according to claim 18, wherein the backshell housing includes a radial groove in the passage, and the assembly further includes a seal disposed in the radial groove and surrounding the header body.
